(19) United States
(12) Patent Application Publication
(10) Pub. No.: US 2023/0285223 A1
(43) Pub. Date: Sep. 14, 2023

(54) AQUATIC MASSAGE ROLLER DEVICE

(71) Applicant: Albert Doelatip, Ewing, NJ (US)

(72) Inventor: Albert Doelatip, Ewing, NJ (US)

(21) Appl. No.: 17/691,522

(22) Filed: Mar. 10, 2022

(51) Int. Cl. A61H 15/00

(52) U.S. Cl. CPC A61H 15/0092; A61H 2015/0014; A61H 2201/1695; A61H 2201/0111

(57) ABSTRACT

An aquatic massage roller device for holding either warmed or cooled water to ameliorate the sore muscles being massaged includes a tube. The tube is cylindrical shaped and has a pair of sides. The tube encloses a hollow interior that can be accessed by a port on a first side of the pair of sides. The hollow interior can store warmed or cooled water to provide relief to the sore muscles when in use. A plurality of knobs enwraps an exterior surface of the tube. The exterior surface of the tube has a cover that insulates the hollow interior. A pair of handles is coupled to a respective one of the pair of sides. The pair of handles is in a fixed position relative to the tube. The user grasps the pair of handles when rolling the tube on the sore muscles.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to thermic massage devices and more particularly pertains to a new thermic massage device for holding either warmed or cooled water to ameliorate the sore muscles being massaged.

### (2) Description of Related Art Including Information Disclosed Under 37 CFR 1.97 and 1.98

The prior art relates to thermic massage devices. The prior art includes a variety of thermic massage devices having a cylindrical shape. Furthermore, know prior art includes a variety of thermic massage devices being configured for holding liquids such as water. Known prior art lacks a thermic massage device being configured for holding water and having a plurality of knobs enwrapped around the cylindrical shape being configured for assisting in massaging the user.

### BRIEF SUMMARY OF THE INVENTION

An embodiment of the disclosure meets the needs presented above by generally comprising a tube. The tube has an exterior surface and a pair of sides. The tube has a hollow interior where the hollow interior defines a space for water to be stored within. The exterior surface of the tube has a plurality of knobs. The plurality of knobs is configured for assisting in massaging the user. A port is positioned on a first side of the pair of sides. The port is configured for providing a portal to the hollow interior. The port has a plug. The plug of the port is configured for being inserted into the port whereby enclosing the hollow interior. Each handle of a pair of handles has an attached side. The attached side of each of the handles is coupled to a respective one of each of the side of the tube. The pair of handles is configured for be grabbed by the hands of the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of an aquatic massage roller device according to an embodiment of the disclosure.

FIG. 2 is a side view of an embodiment of the disclosure.

FIG. 3 is a cross-sectional view of an embodiment of the disclosure taken from FIG. 2 of Line 3-3.

FIG. 4 is an in-use view of an embodiment of the disclosure.

### DETAILED DESCRIPTION OF THE INVENTION

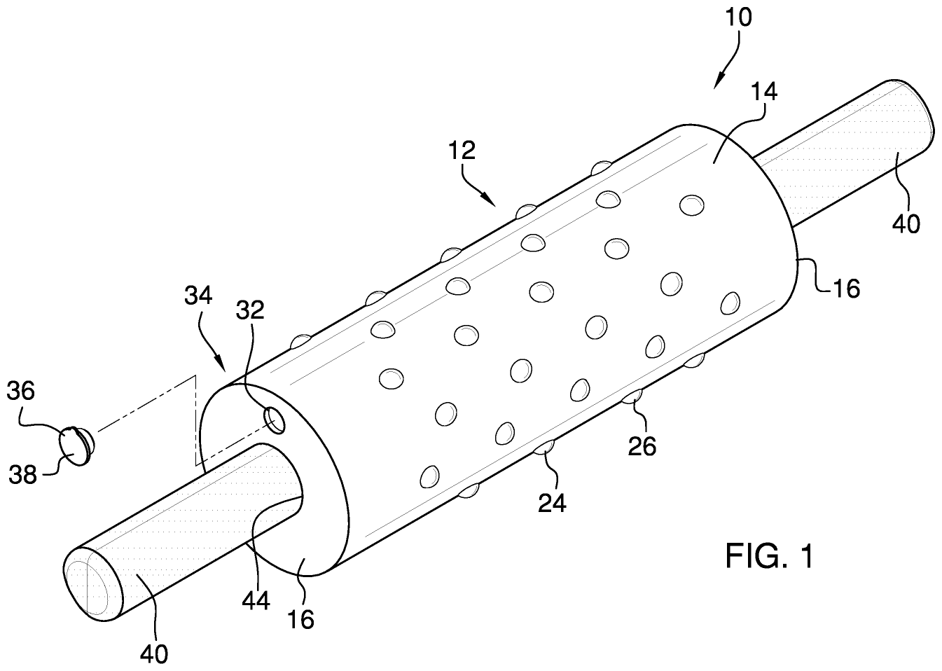

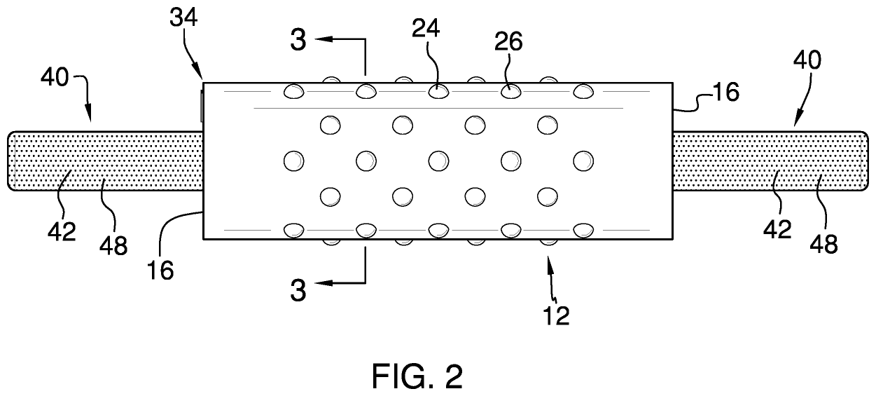

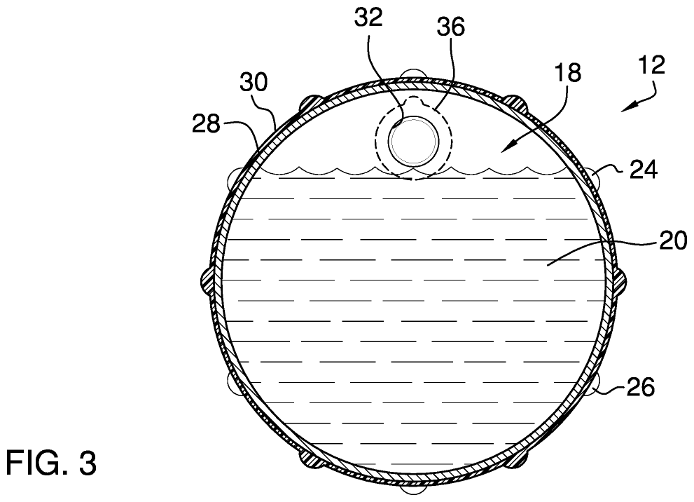

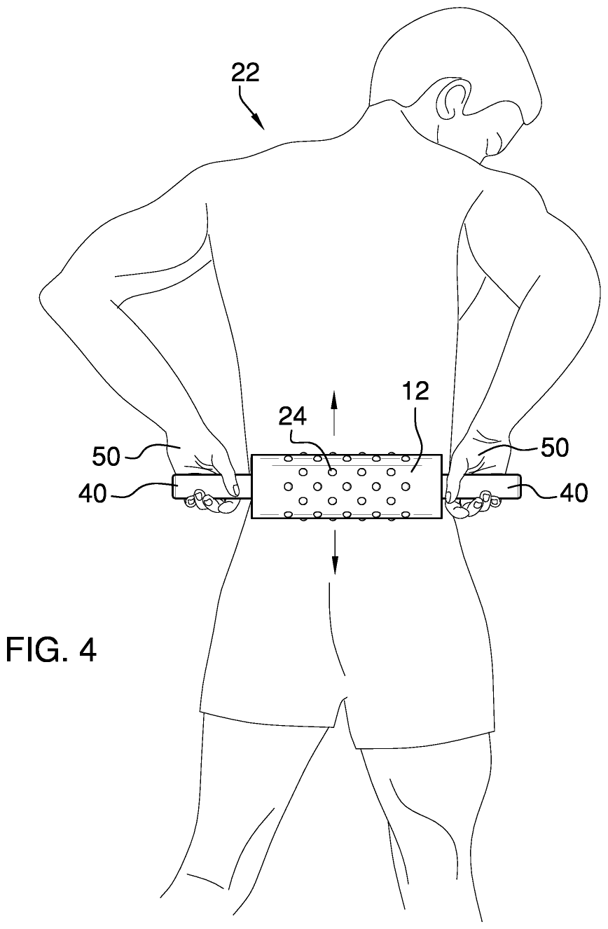

With reference now to the drawings, and in particular to FIGS. 1 through 4 thereof, a new thermic massage device embodying the principles and concepts of an embodiment of the disclosure and generally designated by the reference numeral 10 will be described.

As best illustrated in FIGS. 1 through 4, the aquatic massage roller device 10 generally comprises a tube 12. The tube 12 is a cylindrical shape with an exterior surface 14 and a pair of sides 16. Each of the sides 16 is circular and parallel to each other. The tube 12 has a hollow interior 18 which defines a space for warmed or cooled water 20 to be stored within. The tube 12 is configured for holding the warmed or cooled water 20 that will assist with massaging the user 22.

The exterior surface 14 of the tube 12 has a plurality of knobs 24. Each of the knobs 24 is a semi-spherical shape 26 bulging outward from the exterior surface 14 of the tube 12. The plurality of knobs 24 is configured for ameliorating the sore muscles when rolling the tube 12 on the user 22. Furthermore, a cover 28 enwraps the exterior surface 14 of the tube 12. The cover 28 is a silicone material 30 and is configured for providing insulation to the warmed or cooled water 20 within the hollow interior 18.

A port 32 is positioned on a first side 34 of the pair of sides 16. The port 32 is an aperture and is circular. The port 32 is configured for providing a portal to the hollow interior 18. The user 22 fills and drains the hollow interior with the warmed or cooled water 20. A plug 36 is inserted into the port 32 whereby enclosing the hollow interior 18. The plug 36 is a rubber material 38 being configured for retaining in the port 32 by friction from the adhesive properties of the rubber material 38. The plug 36 can be removed from the port 32 when needed.

Each handle 40 of a pair of handles 40 is a cylindrical shape. Each of the handles 40 has an outer surface 42 and each of the handles 40 has an attached side 44. The attached side 44 of each of the handles 40 is coupled to a respective one of each of the sides 16 of the tube 12. Each of the handles 40 is positioned in respective one of a center 46 of each of the sides 16 of the tube 12. The pair of handles 40 is in a fixed position relative to the tube 12. Each of the handles 40 has a grip 48 on the outer surface 42 of each of the handles 40. The grip 48 is configured for providing traction for the hands 50 of the user 22 when rolling the tube 12. The pair of handles 40 is configured for being grasped by the user 22 when in use.

In use, the user 22 removes the plug 36 from the port 32. The user 20 can fill the hollow interior 18 of the tube 12 with the warmed or cooled water 20. After filling the hollow interior 18, the plug 36 is inserted into the port 32 and the plug 36 is retained in a fixed position relative to the port 32 due to friction of the rubber material 38. The hands 50 of the user 22 grasp the pair of handles 40 and roll the tube 12 over the sore muscles of the user 22. The plurality of knobs 24 helps the tube 12 massage the sore muscles and the warmed or cooled water 20 helps with alleviating any pain the sore muscles have. When completed, the user 22 removes the plug 36 from the port 32 and drains the hollow interior 18 of the warmed or cooled water 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. an aquatic massage roller device comprising:
a tube, said tube having an exterior surface, said tube having a pair of sides, said tube having a hollow interior, said hollow interior defining a space for water to be stored within, said exterior surface of said tube having a plurality of knobs, said plurality of knobs being configured for assisting in massaging the user;
a port, said port being positioned on a first side of said pair of sides, said port being configured for providing a portal to said hollow interior, said port having a plug, said plug of said port being configured for being inserted into said port whereby enclosing said hollow interior; and
a pair of handles, each of said handles having an attached side, said attached side of each of said handles being coupled to a respective one of each of said sides of said tube, said pair of handles being configured for being grabbed by the hands of the user.

2. The aquatic massage roller device of claim 1, further comprising said tube being a cylindrical shape.

3. The aquatic massage roller device of claim 1, further comprising each of said sides being circular.

4. The aquatic massage roller device of claim 1, further comprising said pair of sides being parallel to each other.

5. The aquatic massage roller device of claim 1, further comprising each of said knobs being a semi-spherical shape.

6. The aquatic massage roller device of claim 1, further comprising said exterior surface having a cover, said cover being a silicone material.

7. The aquatic massage roller device of claim 6, further comprising said silicone material being configured for insulation of said hollow interior of said tube;

8. The aquatic massage roller device of claim 1, further comprising said port being an aperture.

9. The aquatic massage roller device of claim 8, further comprising said port being circular.

10. The aquatic massage roller device of claim 1, further comprising said plug being a rubber material.

11. The aquatic massage roller device of claim 10, further comprising said plug being retained in said port by friction from said rubber material.

12. The aquatic massage roller device of claim 11, further comprising said plug can be removed from said port.

13. The aquatic massage roller device of claim 1, further comprising each of said handles being a cylindrical shape.

14. The aquatic massage roller device of claim 13, further comprising each of said handles having an outer surface.

15. The aquatic massage roller device of claim 2, further comprising each of said handles being positioned in a respective one of a center of each of said sides.

16. The aquatic massage roller device of claim 14, further comprising said outer surface of each of said handles having a grip, said grip of each of said handles being configured for providing traction for the hands of the users to roll said tube.

17. An aquatic massage roller device comprising:
a tube, said tube being a cylindrical shape, said tube having an exterior surface, said tube having a pair of sides, each of said sides being circular, said pair of sides being parallel to each other, said tube having a hollow interior, said hollow interior defining a space for water to be stored within, said exterior surface of said tube having a plurality of knobs, each of said knobs being a semi-spherical shape, said plurality of knobs being configured for assisting in massaging the user, said exterior surface having a cover, said cover being a silicone material, said silicone material being configured for insulation of said hollow interior of said tube;
a port, said port being positioned on a first side of said pair of sides, said port being an aperture, said port being circular, said port being configured for providing a portal to said hollow interior, said port having a plug, said plug being a rubber material, said plug of said port being configured for being inserted into said port whereby enclosing said hollow interior, said plug being retained in said port by friction from said rubber material, said plug can be removed from said port; and
a pair of handles, each of said handles being a cylindrical shape, each of said handles having an outer surface, each of said handles having an attached side, said attached side of each of said handles being coupled to a respective one of each of said sides of said tube, each of said handles being positioned in a respective one of a center of each of said sides, said outer surface of each of said handles having a grip, said grip of each of said handles being configured for providing traction for the hands of the users to roll said tube, said pair of handles being configured for being grabbed by the hands of the user.
